(19) United States
(12) Patent Application Publication
(10) Pub. No.: US 2026/0362488 A1
(43) Pub. Date: Nov. 12, 2026

(54) NOTIFICATION PROCEDURE FOR P-EDCA OPERATION IN WLANS

(71) Applicant: Samsung Electronics Co., Ltd., Suwon-si (KR)

(72) Inventors: Peshal Nayak, Plano, TX (US); Yue Qi, Plano, TX (US); Boon Loong Ng, Plano, TX (US); Rubayet Shafin, Frisco, TX (US); Vishnu Vardhan Ratnam, Frisco, TX (US); Bilal Sadiq, Plano, TX (US)

(21) Appl. No.: 19/642,470

(22) Filed: Apr. 8, 2026

Related U.S. Application Data
(60) Provisional application No. 63/802,973, filed on May 9, 2025.
(60) Provisional application No. 63/974,103, filed on Feb. 2, 2026.

(51) Int. Cl. H04W 74/0816; H04W 74/08

(52) U.S. Cl. CPC H04W 74/0816; H04W 74/0875

(57) ABSTRACT

Methods and apparatuses for supporting a notification procedure for priority enhanced distributed channel access (P-EDCA) operation in wireless local area networks (WLANs). A method performed by a non-access point (AP) station (STA) includes receiving, from an AP, information indicating enablement of prioritized enhanced distributed channel access (P-EDCA). The method further includes transmitting, to the AP, a first message indicating an intention to use P-EDCA.

### CROSS-REFERENCE TO RELATED APPLICATION(S) AND CLAIM OF PRIORITY

This application claims priority under 35 U.S.C. § 119 (e) to U.S. Provisional Patent Application No. 63/802,973, filed on May 9, 2025, and U.S. Provisional Patent Application No. 63/974,103, filed on Feb. 2, 2026. The above identified provisional patent applications are hereby incorporated by reference in their entirety.

### TECHNICAL FIELD

This disclosure relates generally to wireless communication, and more specifically to a notification procedure for priority enhanced distributed channel access (P-EDCA) operation in wireless local area networks (WLANs).

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for a notification procedure for P-EDCA operation in WLANs.

In one embodiment, a method performed by a non-access point (AP) station (STA) includes receiving, from an AP, information indicating enablement of prioritized enhanced distributed channel access (P-EDCA). The method further includes transmitting, to the AP, a first message indicating an intention to use P-EDCA.

In another embodiment, a method performed by an AP includes transmitting, to a non-AP STA, information indicating enablement of P-EDCA. The method further comprises receiving, from the non-AP STA, a first message indicating an intention to use P-EDCA.

In yet another embodiment, a non-AP STA comprises at least one processor including processing circuitry, and memory storing instructions. The instructions, when executed by the at least one processor individually or collectively, cause the non-AP STA to receive, from an AP, information indicating enablement of P-EDCA. The instructions, when executed by the at least one processor individually or collectively, cause the non-AP STA to transmit, to the AP, a first message indicating an intention to use P-EDCA.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example of usage notification according to embodiments of the present disclosure;

FIG. 4 illustrates an example usage notification example format according to embodiments of the present disclosure; and

FIG. 5 illustrates an example method performed by a non-access point (AP) station (STA) in a wireless communication system according to embodiments of the present disclosure.

### DETAILED DESCRIPTION

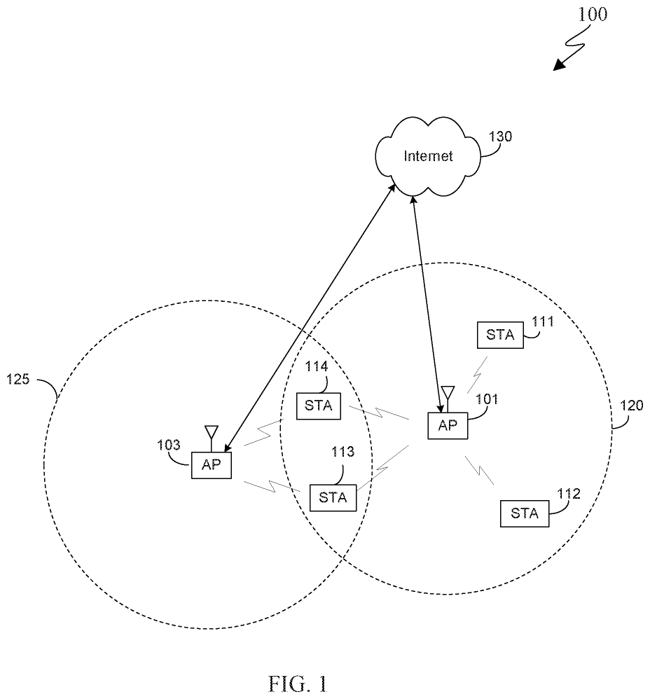

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D2.0, 2022; [2] IEEE Std. 802.11-2020.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for supporting a notification procedure for P-EDCA operation in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

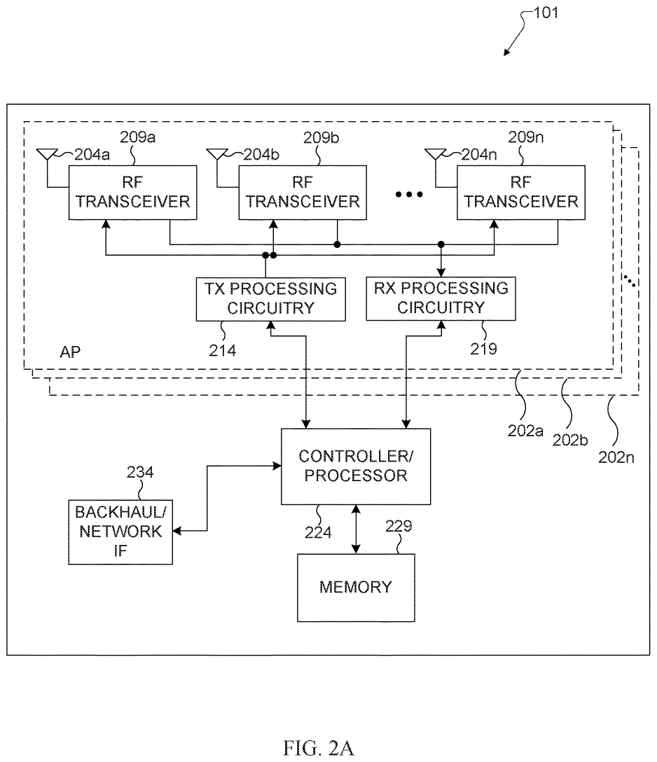

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including anchor link design for multi-link operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for supporting a notification procedure for P-EDCA operation in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHZ, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to support a notification procedure for P-EDCA operation in WLAN. In some embodiments, the processor 240 includes at least one microprocessor or microcontroller.

The processor 240 is also capable of executing other processes and programs resident in the memory 260, such as operations for supporting a notification procedure for P-EDCA operation in WLANs. The processor 240 can move data into or out of the memory 260 as required by an executing process. In some embodiments, the processor 240 is configured to execute a plurality of applications 262, such as applications for supporting a notification procedure for P-EDCA operation in WLANs. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize that in next generation WLANs, a P-EDCA procedure can be considered. In this procedure, a P-EDCA capable STA can transmit a defer signal (DS) to initiate a contention period. Only STAs that transmit the DS signal can participate in such a contention period. The DS can be a clear to send (CTS) frame carrying specific pre-determined contents in different fields. The STA that wins this contention can transmit one or more low latency (possibly AC VO) frame. The feature can be enabled or disabled by the AP for all STAs in its basic service set (BSS).

Embodiments of the present disclosure recognize that when a non-AP MLD/non-AP STA is associated with an AP MLD/AP STA, the non-AP MLD can have one or more non-AP STAs affiliated with it. Likewise, the AP MLD can have one or more AP STAs affiliated with it. A STA can use P-EDCA to reduce the access delay distribution tail for AC_VO traffic. The STA can start a P-EDCA contention if all of the conditions are satisfied-(a) P-EDCA is enabled by the AP in the BSS, (b) the P-EDCA STA has pending AC_VO buffered traffic and (c) QSRC[AC_VO] is equal to or greater than dot11PEDCARetryThreshold and PSRC[AC_VO] is less than dot11PEDCAConsecutiveAttempt. To start the P-EDCA contention, the P-EDCA STA can transmit a DS-CTS frame. The transmission of the DS-CTS frame can occur at the DSAIFS[AC_VO] slot boundary if the STA's carrier sensing mechanism determines that the medium is idle. The DSAIFS[AC_VO] can be a duration derived from the following equation: DSAIFS[AC_VO]=aSIFSTime+ (AIFSN+DSr)×aSlotTime where AIFSN is 2 and DSr can be an integer value chosen randomly with a uniform distribution taking values in the range 0 to CWds[AC_VO] for every transmission of DS-CTS frame.

The P-EDCA contention can start immediately after the end of the transmitted DS-CTS frame and can follow the random backoff procedure defined in [2] except that: (a) only EDCAF[AC_VO] can be allowed to contend during the P-EDCA contention. Operation of the other EDCAFs can be suspended, (b) The EDCAF[AC_VO] can initialize AIFSN, CWmin, and CWmax with the values of P-EDCA AIFSN, P-EDCA CWmin, and P-EDCA CWmax respectively. CW[AC_VO] can be initialized to CWmin[AC_VO], (c) The EDCAF[AC_VO] can set the backoff counter to an integer value chosen randomly with a uniform distribution taking values in the range 0 to CW[AC_VO].

If the P-EDCA STA successfully delivered one or more pending MPDUs in a TXOP obtained during P-EDCA contention it cannot start P-EDCA contention until conditions to start P-EDCA contention are satisfied. Additionally, the EDCAF[AC_VO] can update AIFSN, CWmin, and CWmax with the values in dot11EDCATable (dot11QAPEDCATable for the AP) and an operation of EDCAF[AC_VI], EDCAF[AC_BE], EDCAF[AC_BK] can be resumed. Additionally, CW[AC_VO] can be initialized to CWmin[AC_VO].

When an AP enables or disables P-EDCA for all the STAs in its BSS, it does not know how many and which STAs can get impacted by this operation. This information can be useful for the AP to assess the impact that P-EDCA usage can have on its BSS traffic from legacy STAs. Further, the information can be useful for the AP to assist those STAs that were using P-EDCA in case it disables P-EDCA feature. It can also be useful for the AP to assess if too many P-EDCA attempts can be expected in the BSS and understand any impact to its scheduler. A procedure and behavior is needed to handle this.

Accordingly, the present disclosure provides a number of solutions for handling P-EDCA usage notification. Aspects include: notification regarding intention to use P-EDCA; notification regarding intention to not use P-EDCA; AP-side behavior; STA-side behavior; example signaling.

Regarding notification regarding intention to use P-EDCA, according to one embodiment, a STA that intends to use P-EDCA can transmit a notification message to the AP. The notification message can be transmitted to the AP that the STA can be associated with. The notification message can be transmitted after P-EDCA has been enabled by the AP in the BSS. The STA can understand that P-EDCA has been enabled by the AP if it receives such a enablement indication from the AP. E.g., AP transmits an enablement indication in the beacon.

The notification message mentioned above can contain at least one or more of the information items as shown in Table 1.

Table 1 Information items that can be present in the notification message

| Information items | Description |
|---|---|
| Usage | One or more information items that can indicate |
| intention | to the AP that the STA intends to use P-EDCA. |
| notification | E.g., a bit that can take a predetermined value |
| | (e.g., 1) to make the indication. |
| Usage | One or more information items that can indicate |
| duration | to the AP the duration for which the P-EDCA can |
| | be used by the STA. E.g., duration in terms of |
| | TUs, Beacon intervals, etc. |

According to one embodiment, the above message can be a notification.

According to another embodiment, the above message can be a request and the AP can either accept or reject the request.

According to another embodiment, the above message can be a request to enable P-EDCA and the AP can consider to enable or disable P-EDCA based on the request.

The enablement notification can also be transmitted by an AP to inform the STA that it can use P-EDCA. For example, if the AP's scheduler can no longer meet the STA's traffic requirements (e.g., as indicated in the QoS characteristic element during SCS setup), then the AP can notify the STA that it can use P-EDCA.

Regarding notification regarding intention to not use P-EDCA, according to one embodiment, a STA that no longer intends to use P-EDCA can transmit a notification message to the AP. The notification message can be transmitted to the AP that the STA can be associated with. The notification message can be transmitted if the STA has already notified the AP in the past that it intends to use P-EDCA.

If an AP disables P-EDCA, then the STA does not have to transmit this notification and AP can consider P-EDCA disabled in the BSS.

The notification message mentioned above can contain at least one or more of the information items as shown in Table 2.

Table 2 Information items that can be present in the notification message

| Information items | Description |
|---|---|
| No usage | One or more information items that can indicate |
| intention | to the AP that the STA does not intend to use P-EDCA. |
| notification | E.g., a bit that can a predetermined value (e.g., 0) |
| | to make the indication. |

The disablement notification can also be transmitted by the AP to control the number of STAs that use P-EDCA. E.g., if AP has a higher priority STA in the network (e.g., EPCS STA, STA with even lower latency traffic, STA with higher priority traffic) then AP can disable P-EDCA for one or more STAs (e.g., STAs with lower priority) in the network.

Regarding AP-side behavior, an AP can enable P-EDCA in the BSS. After P-EDCA is enabled, the AP can receive notification from STAs that intend to use P-EDCA.

An AP can understand how many STAs can use P-EDCA based on the notification.

If it is an enablement request from the STA, then AP can consider to enable or disable P-EDCA based on the request.

Regarding SRA-side behavior, a STA can receive an indication from an AP regarding P-EDCA enablement. After receiving such an indication, the STA can transmit a notification of usage to the AP. When a STA no longer intends to use P-EDCA (e.g., AC VO application has been turned off by the user), the STA can transmit a disablement notification to the AP.

The STA can use P-EDCA only when it has notified the AP about the intention to use P-EDCA.

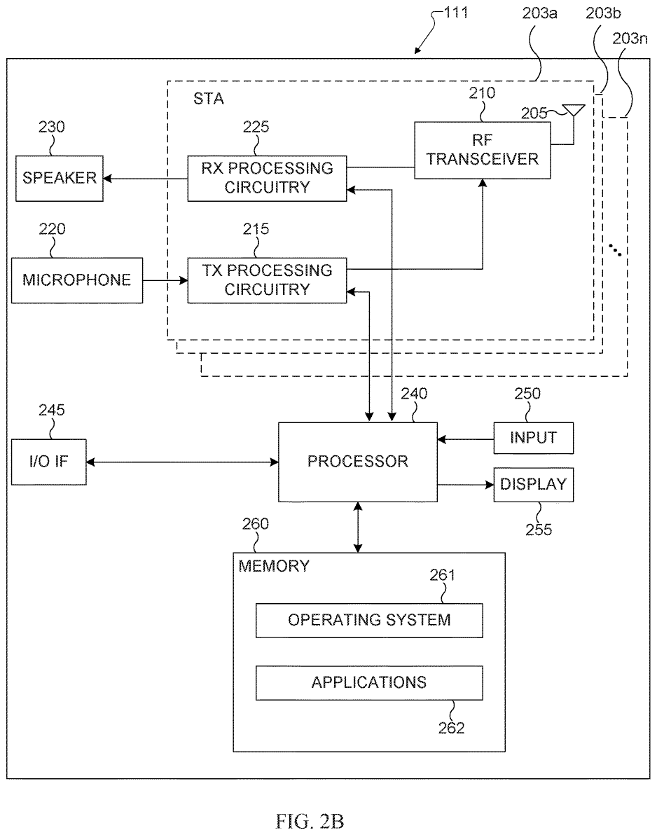

FIG. 3 illustrates an example of usage notification 300 according to embodiments of the present disclosure. The embodiment of the usage notification 300 of FIG. 3 is for illustration only. Different embodiments of the usage notification 300 could be used without departing from the scope of this disclosure.

According to one embodiment, the usage and no usage notification can be transmitted via a link reconfiguration request frame.

The link reconfiguration request frame can carry an operation mode change notification message to make the indication.

For example, there can be an element which can have a field in it to make the indication as shown in FIG. 3.

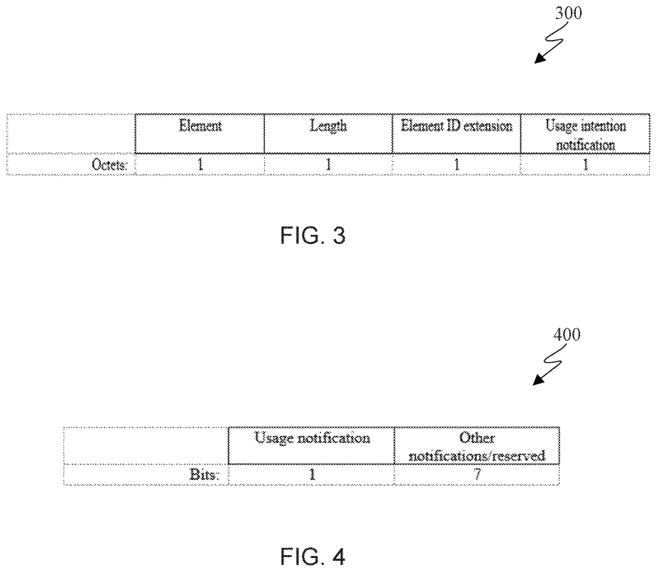

FIG. 4 illustrates an example usage notification example format 400 according to embodiments of the present disclosure. The embodiment of the usage notification example format 400 of FIG. 4 is for illustration only. Different embodiments of the usage notification example format 400 could be used without departing from the scope of this disclosure.

The usage notification can take a value of 1 to make a notification of the STA's intention to use P-EDCA. The usage notification can take a value of 0 to make a notification of the STA's intention to not use P-EDCA.

The above element can be carried in the per-STA profile in a reconfiguration multi-link element. The per-STA profile can correspond to the STA on the link for which the notification corresponds to.

According to one embodiment, the above notification can be transmitted in a link reconfiguration notify frame. The above element can be carried in the per-STA profile in a reconfiguration multi-link element. The per-STA profile can correspond to the STA on the link for which the notification corresponds to.

The link reconfiguration notify frame can have a format as shown in Table 3.

Table 3 Modified link reconfiguration notify frame format

| Order | Meaning |
|---|---|
| 1 | Category |
| 2 | Protected UHR Action |
| 3 | Dialog Token |
| 4 | Type |

The type field can take a new encoding to convey the intent to use P-EDCA as shown in Table 4.

Table 4 Type field encoding

| Value | Meaning |
|---|---|
| 0-1 | Reserved |
| 2 | An indication of early termination of the |
| | DL draining period or no more DL data. |
| 3 | OMP response |
| 4 | A confirmation response to a UHR Link |
| | Reconfiguration Notify frame received |
| | from a DSO AP with Type field equal to 3. |
| 5 | P-EDCA usage intent notification |
| 6 | P-EDCA usage confirmation |
| 7 | P-EDCA no usage intent notification |
| 8-255 | Reserved |

The type field can be set to an encoding show in Table 4 to indicate that the STA intends to use P-EDCA (see example value 5 in Table 4).

According to one embodiment, upon receiving the above link reconfiguration notify frame, the AP can transmit another frame which can also be a link reconfiguration notify frame which can have a new type field indicating a confirmation to use P-EDCA (see example value 6 in Table 4).

According to another embodiment, upon receiving the above message from an AP in a link reconfiguration notify frame, the STA can transmit a link reconfiguration request frame to confirm the notification. There can be a new type field value (see example value 6 in Table 4).

When the STA does not intend to use P-EDCA, it can transmit a link reconfiguration notify frame with a type value to indicate an intention to not use P-EDCA (see example value 7 in Table 4).

According to one embodiment, the usage notification can be made through a A-control subfield. There can be a one bit notification in an A-control subfield.

According to one embodiment, the usage notification can be carried in a newly defined management frame.

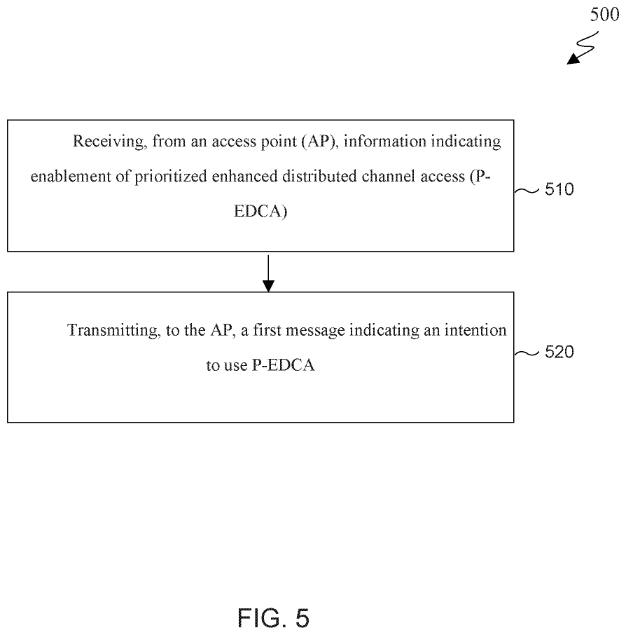

FIG. 5 illustrates an example method 500 performed by a non-access point (AP) station (STA) in a wireless communication system according to embodiments of the present disclosure. The method 500 of FIG. 5 can be performed by any of the STAs 111-114 of FIG. 1, such as the STA 111 of FIG. 2B, and a corresponding method can be performed by any of the APs 101-103 of FIG. 1, such as AP 101 of FIG. 2A. The method 500 is for illustration only and other embodiments can be used without departing from the scope of the present disclosure.

As illustrated in FIG. 5, the method 500 begins at step 510, where the non-AP STA receives, from an AP, information indicating enablement of prioritized enhanced distributed channel access (P-EDCA). At step 520, the non-AP STA transmits, to the AP, a first message indicating an intention to use P-EDCA.

In some embodiments, the first message includes at least one of: at least one information item that indicates to the AP that the non-AP STA intends to use P-EDCA; and at least one information item that indicates to the AP a duration for which the P-EDCA can be used by the non-AP STA.

In some embodiments, when the non-AP STA no longer intends to use P-EDCA, the non-AP STA transmits, to the AP, a second message indicating an intention to no longer use P-EDCA.

In some embodiments, the second message includes at least one information item that indicates to the AP that the non-AP STA no longer intends to use P-EDCA.

In some embodiments, the non-AP STA receives, from the AP, information indicating disablement of P-EDCA such that the non-AP STA can no longer use P-EDCA.

In some embodiments, the non-AP STA transmits the first message in a link reconfiguration request frame.

In some embodiments, the non-AP STA transmits the first message in a link reconfiguration notify frame.

In some embodiments, the non-AP STA receives, from the AP, a response frame including information indicating a confirmation to use P-EDCA.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a non-access point (AP) station (STA), the method comprising:
receiving, from an AP, information indicating enablement of prioritized enhanced distributed channel access (P-EDCA); and
transmitting, to the AP, a first message indicating an intention to use P-EDCA.

2. The method of claim 1, wherein the first message includes at least one of:
at least one information item that indicates to the AP that the non-AP STA intends to use P-EDCA; and
at least one information item that indicates to the AP a duration for which the P-EDCA can be used by the non-AP STA.

3. The method of claim 1, further comprising, when the non-AP STA no longer intends to use P-EDCA:
transmitting, to the AP, a second message indicating an intention to no longer use P-EDCA.

4. The method of claim 3, wherein the second message includes at least one information item that indicates to the AP that the non-AP STA no longer intends to use P-EDCA.

5. The method of claim 1, further comprising receiving, from the AP, information indicating disablement of P-EDCA such that the non-AP STA can no longer use P-EDCA.

6. The method of claim 1, further comprising transmitting the first message in a link reconfiguration request frame.

7. The method of claim 1, further comprising transmitting the first message in a link reconfiguration notify frame.

8. The method of claim 7, further comprising receiving, from the AP, a response frame including information indicating a confirmation to use P-EDCA.

9. A method performed by an access point (AP), the method comprising:
transmitting, to a non-AP station (STA), information indicating enablement of prioritized enhanced distributed channel access (P-EDCA); and
receiving, from the non-AP STA, a first message indicating an intention to use P-EDCA.

10. The method of claim 9, wherein the first message includes at least one of:
at least one information item that indicates to the AP that the non-AP STA intends to use P-EDCA; and
at least one information item that indicates to the AP a duration for which the P-EDCA can be used by the non-AP STA.

11. The method of claim 9, further comprising, when the non-AP STA no longer intends to use P-EDCA:
receiving, from the AP, a second message indicating an intention to no longer use P-EDCA.

12. The method of claim 11, wherein the second message includes at least one information item that indicates to the AP that the non-AP STA no longer intends to use P-EDCA.

13. The method of claim 9, further comprising transmitting, to the non-AP STA, information indicating disablement of P-EDCA such that the non-AP STA can no longer use P-EDCA.

14. The method of claim 9, further comprising receiving the first message in a link reconfiguration request frame.

15. The method of claim 9, further comprising receiving the first message in a link reconfiguration notify frame.

16. The method of claim 15, further comprising receiving, from the non-AP STA, a response frame including information indicating a confirmation to use P-EDCA.

17. A non-access point (AP) station (STA) comprising:
at least one processor including processing circuitry; and
memory storing instructions, wherein the instructions, when executed by the at least one processor individually or collectively, cause the first STA to:
receive, from an AP, information indicating enablement of prioritized enhanced distributed channel access (P-EDCA); and
transmit, to the AP, a first message indicating an intention to use P-EDCA.

18. The non-AP STA of claim 17, wherein the first message includes at least one of:
at least one information item that indicates to the AP that the non-AP STA intends to use P-EDCA; and
at least one information item that indicates to the AP a duration for which the P-EDCA can be used by the non-AP STA.

19. The non-AP STA of claim 17, wherein when the non-AP STA no longer intends to use P-EDCA, the instructions, when executed by the at least one processor individually or collectively, cause the first STA to transmit, to the AP, a second message indicating an intention to no longer use P-EDCA.

20. The non-AP STA of claim 19, wherein the instructions, when executed by the at least one processor individually or collectively, cause the first STA to receive, from the AP, information indicating disablement of P-EDCA such that the non-AP STA can no longer use P-EDCA.
